(19) United States
(12) Patent Application Publication
(10) Pub. No.: US 2018/0108935 A1
(43) Pub. Date: Apr. 19, 2018

(54) ELECTROLYTE SOLUTION FOR SECONDARY BATTERIES, AND SECONDARY BATTERY

(71) Applicant: NEC CORPORATION, Tokyo (JP)

(72) Inventors: Takehiro NOGUCHI, Tokyo (JP); Shin SERIZAWA, Tokyo (JP); Yuukou KATOU, Tokyo (JP)

(73) Assignee: NEC CORPORATION, Tokyo (JP)

(21) Appl. No.: 15/569,870

(22) PCT Filed: Apr. 26, 2016
(86) PCT No.: PCT/JP2016/063104

§ 371 Date: Oct. 27, 2017

(30) Foreign Application Priority Data
Apr. 30, 2015 (JP) 2015-093024

(51) Int. Cl. H01M 10/052; H01M 10/0567; H01M 10/0569; H01M 4/505; H01M 4/525

(52) U.S. Cl. CPC H01M 10/052; H01M 10/0567; H01M 2004/028; H01M 4/505; H01M 4/525; H01M 10/0569

(57) ABSTRACT

The object of the present invention is to provide an electrolyte solution for secondary batteries, which improves the cycle characteristics of a secondary battery operating at a high potential and used at a high temperature for a long time. The present invention relates to an electrolyte solution for secondary batteries comprising lithium difluorophosphate, a fluorine containing ether compound and a fluorine containing phosphate ester compound and/or a sulfone compound.

### TECHNICAL FIELD

The present invention relates to an electrolyte solution for lithium ion secondary batteries, a secondary battery, and a method for manufacturing the same.

### BACKGROUND ART

Lithium ion secondary batteries are used for various applications, such as mobile phone equipment and computers, and thereby it is necessary to maintain cycle characteristics and to suppress gas generated in a battery even if usable temperature range is set higher than before. In addition, batteries operable at a higher potential than before are developed, and even if voltage is high, equivalent cycle characteristics are required.

Decomposition reaction of electrolyte solution tends to proceed at a contact portion between a positive electrode and electrolyte solution during operation at a voltage which is higher than conventional. Especially at high temperatures, gas is generated due to this decomposition reaction. Since the gas generation raises internal pressure of a cell and causes cell swelling, it is a problem in practical use. Therefore, it is expected to develop an electrolyte solution that suppresses such gas generation and excellent in voltage resistance and high temperature durability. A fluorinated solvent and the like are considered as the electrolyte solution excellent in high voltage resistance that can suppress gas generation. Candidates thereof include fluorinated solvents such as fluorinated carbonates, fluorinated carboxylic esters, fluorine-containing ether compounds, and fluorine-containing phosphate ester compounds. However, since the fluorinated solvents have low compatibility with electrolyte solution and have high viscosity, excellent cycle characteristics and the effect of decreasing the gas generation cannot be obtained unless composition of the electrolyte solution is optimized. From this viewpoint, selection of composition of the electrolyte solution is important for improving its characteristics. It has been further necessary to develop electrolyte solution additives and supporting salts suitable for an electrolyte solution functioning at a high potential. Patent Documents 1 and 2 disclose a battery with the electrolyte solution adapted to such a high voltage state. In the lithium ion secondary battery of Patent Document 1, high temperature cycle characteristics are improved by using fluorine containing ether compounds in an amount of 10 to 60 volume % in the electrolyte solution in addition to controlling the average particle diameter and the specific surface area of a positive electrode active material. The lithium ion secondary battery of Patent Document 2 exhibits excellent cycle characteristics by comprising fluorine containing phosphate ester compounds in a non-aqueous solvent, although it has high energy density.

### CITATION LIST

### Patent Document

Patent Document 1: WO2011/162169

Patent Document 2: WO2012/077712

### SUMMARY OF INVENTION

### Technical Problem

However, there is a problem that a decrease in discharge capacity is still seen even in the lithium ion secondary battery described in the above-mentioned prior art documents when charge and discharge cycles are repeated, and an electrolyte solution more excellent in voltage resistance and high temperature durability is required.

An object of the present invention is to provide an electrolyte solution improving cycle characteristics of secondary batteries under high temperature and high voltage, which is the above mentioned problem.

### Solution to Problem

The lithium ion secondary battery of the present invention is characterized in comprising at least one selected from fluorine containing ether compounds denoted by the formula (1), at least one selected from fluorine containing phosphate ester compounds denoted by the formula (2) and sulfone compounds denoted by the formula (3), and lithium difluorophosphate,

R₁—O—R₂ (1)

wherein R₁ and R₂ are each independently an alkyl group or a fluorine containing alkyl group, and at least one of R₁ and R₂ is a fluorine containing alkyl group,

O═P(—O—R₁′)(—O—R₂′)(—O—R₃′) (2)

wherein R₁′, R₂′ and R₃′ are each independently an alkyl group or a fluorine containing alkyl group, and at least one of R₁′, R₂′ and R₃′ is a fluorine containing alkyl group,

R₁″—SO₂—R₂″ (3)

wherein R₁″ and R₂″ are a substituted or non-substituted alkyl group or alkylene group, wherein when R₁″ and R₂″ represent an alkylene group, the sulfone compound denoted by the formula (3) is a cyclic compound in which carbon atoms of R₁″ and R₂″ are bonded through a single bond or a double bond.

### Advantageous Effect of Invention

By adopting the constitution of the present invention, there can be provided an electrolyte solution for secondary batteries which improves the cycle characteristics of a secondary battery even under high energy density.

### BRIEF DESCRIPTION OF DRAWING

FIG. 1 is a view showing cross-sectional structure of a secondary battery.

FIG. 2 is an exploded perspective view showing a basic structure of a film package battery.

FIG. 3 is a cross-sectional view schematically showing a cross section of the battery of FIG. 2.

### DESCRIPTION OF EMBODIMENTS

Preferable embodiments of the present invention will be described below.

The electrolyte solution for secondary batteries of the present invention comprises fluorine containing ether compounds, fluorine containing phosphate ester compounds and/or sulfone compounds, and lithium difluorophosphate.

In the present embodiment, it is preferable that the concentration of lithium difluorophosphate in the electrolyte solution is 0.05% by mass or more and 10% by mass or less. If the composition of lithium difluorophosphate is low, the film effect on the positive electrode and the life improvement effect are decreased. If it is too much, the viscosity of the electrolyte solution increases and the charge and discharge capacity decreases in some cases. The concentration of lithium difluorophosphate in the electrolyte solution is more preferably 0.1% by mass or more and 3% by mass or less, and still more preferably 0.2% by mass or more and 2% by mass or less.

At least one of the fluorine containing ether compounds comprised in the electrolyte solution for secondary batteries of the present invention is denoted by the following formula (1),

R₁—O—R₂ (1)

wherein R₁ and R₂ are each independently an alkyl group or a fluorine containing alkyl group, at least one of R₁ and R₂ is a fluorine containing alkyl group. The number of carbon atoms in the alkyl group of R₁ and R₂ is preferably 1 or more and 7 or less respectively.

A fluorine substitution rate of the alkyl groups of the fluorine containing ether compound is preferably 20% or more and 100% or less. It is suitable for a use in a high potential positive electrode because the oxidation resistance of the electrolyte solution is improved by increasing the fluorine substitution amount. If the fluorine substitution amount is too large, the solubility of supporting salt and the like decreases and the battery capacity decreases in some cases. In addition, when the fluorine substitution rate is high, lithium difluorophosphate is difficult to dissolve in the electrolyte solution in some cases. The fluorine substitution ratio is more preferably 30% or more and 95% or less, and still more preferably 40% or more and 90% or less. In the formula (1), it is preferable that both of R₁ and R₂ are a fluorine containing alkyl group from because of excellent oxidation resistance. In this specification, the term, “fluorine substitution ratio” represents a ratio of the number of fluorine atoms to the total number of hydrogen atoms and fluorine atoms in a fluorine containing compound (fluorinated compound) or a functional group comprised in a fluorine containing compound.

Examples of the fluorine containing ether include 2,2,3,3,3-pentafluoropropyl 1,1,2,2-tetrafluoroethyl ether, 1,1,2,2-tetrafluoroethyl 2,2,2-trifluoroethyl ether, 1H,1H,2′H, 3H-decafluorodipropyl ether, 1,1,2,3,3,3-hexafluoropropyl 2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H,1H,5H-perfluoropentyl 1,1,2,2-tetrafluoroethyl ether, 1H-perfluorobutyl 1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, 1,1,2,2-tetrafluoroethyl-2,2,3,3-tetrafluoropropyl ether, 2,2,3,3,3-pentafluoropropyl 1,1,2,2-tetrafluoroethyl ether, ethyl nonafluorobutyl ether, methyl nonafluorobutyl ether, 1,1-difluoroethyl 2,2,3,3-tetrafluoropropyl ether, 1,1-difluoroethyl 1H,1H-heptafluorobutyl ether, 2,2,3,4,4,4-hexafluorobutyl difluoromethyl ether, bis(2,2,3,3,3-pentafluoropropyl)ether, nonafluorobutyl methyl ether, bis(1H,1H-heptafluorobutyl)ether, 1,1,2,3,3,3-hexafluoropropyl 1H,1H-heptafluorobutyl ether, 1H,1H-heptafluorobutyl trifluoromethyl ether, 2,2-difluoroethyl 1,1,2,2-tetrafluoroethyl ether, bis(trifluoroethyl)ethter, bis(2,2-difluoroethyl)ether, bis(1,1,2-trifluoroethyl)ether, 1, 1,2-trifluoroethyl 2,2,2-trifluoroethyl ether, bis(2,2,3,3-tetrafluoropropyl)ether and the like.

Among them, from the viewpoint of voltage resistance properties and boiling point, it is preferable to use at least one fluorine containing ether selected from 1,1,2,2-tetrafluoroethyl 2,2,3,3-tetrafluoropropyl ether, 2,2,3,4,4,4-hexafluorobutyl difluoromethyl ether, 1,1-difluoroethyl 2,2,3,3-tetrafluoropropyl ether, 1,1,2,3,3,3-hexafluoropropyl 2,2-difluoroethyl ether, 1,1-difluoroethyl 1H,1H-heptafluorobutyl ether, 1H,1H,2′H,3H-decafluorodipropyl ether, bis(2,2,3,3,3-pentafluoropropyl) ether, 1H,1H,5H-perfluoropentyl 1,1,2,2-tetrafluoroethyl ether, bis(1H,1H-heptafluorobutyl) ether, 1H,1H,2′H-perfluorodipropyl ether, 1, 1,2,3,3,3-hexafluoropropyl 1H,1H-heptafluorobutyl ether, 1H-perfluorobutyl 1H-perfluoroethyl ether, bis(2,2,3,3-tetrafluoropropyl) ether.

The fluorine containing ether compounds may be used in alone or in combination of two or more. When two or more kinds of the fluorine containing ether compounds are used in combination, the cycle characteristics of the secondary battery may be improved, compared to the case where only one kind of the fluorine containing ether compound is used in some cases.

The concentration of the fluorine containing ether compounds in the electrolyte solution is preferably 10% by volume or more and 90% by volume or less. The fluorine containing ether compounds have high oxidation resistance and therefore, the fluorine containing ether compounds are effective as a solvent for positive electrode active materials operating at a high potential. However, when the concentration is too high, the charge and discharge capacity may decrease in some cases because it has low solubility of the supporting salts. The concentration of the fluorine containing ether compounds in the electrolyte solution is more preferably 20% by volume or more and 80% by volume or less, and still more preferably 30% by volume or more and 70% by volume or less.

There is a problem that the fluorine-containing ether compound has low compatibility with other solvents in some cases, but by adding the fluorine-containing phosphate ester compound or the sulfone compound, compatibility between the solvents is improved. Even if a solvent having low-compatibility is once homogeneously mixed, when the solvent is left for a long period or when the temperature rises or falls, the solvent separates in some cases. However, by mixing the fluorine containing ether compound with the fluorine containing phosphate ester compound and/or the sulfone compound, long-term stability of the electrolyte solution can be improved. Therefore, the electrolyte solution of the present invention comprises the fluorine containing phosphate ester compound and/or the sulfone compound together with the fluorine containing ether compound. In particular, it is preferable that the electrolyte solution comprises both of the fluorine containing phosphate ester compound and the sulfone compound together with the fluorine containing ether compound. Since the fluorine-containing ether compound having a high fluorine substitution rate has low compatibility with other solvents among the fluorine-containing ether compounds, the effect of improving the homogeneity due to mixing with the fluorine-containing phosphate ester compound or the sulfone compound is high. The electrolyte solution of the present invention preferably comprises the fluorine-containing phosphate ester compound and the sulfone compound in an amount of 5% by volume or more and 80% by volume or less, more preferably 10% by volume or more and 60% by volume or less, and most preferably 20% by volume or more and 50% by volume or less.

In the present embodiment, it is preferred to comprise at least one selected from fluorine containing phosphate ester compounds denoted by the formula (2),

O═P(—O—R₁′)(—O—R₂′)(—O—R₃′) (2)

wherein R₁′, R₂′ and R₃′ are each independently an alkyl group or a fluorine containing alkyl group, and at least one of R₁′, R₂′ and R₃′ is a fluorine containing alkyl group. The number of carbon atoms in the alkyl group of R₁′, R₂′ and R₃′ is preferably 1 or more and 5 or less respectively.

Examples of the fluorine containing phosphate ester compound include 2,2,2-trifluoroethyl dimethyl phosphate, bis(trifluoroethyl) methyl phosphate, bistrifluoroethyl ethyl phosphate, tris(trifluoromethyl) phosphate, pentafluoropropyl dimethyl phosphate, heptafluorobutyl dimethyl phosphate, trifluoroethyl methyl ethyl phosphate, pentafluoropropyl methyl ethyl phosphate, heptafluorobutyl methyl ethyl phosphate, trifluoroethyl methyl propyl phosphate, pentafluoropropyl methyl propyl phosphate, heptafluorobutyl methyl propyl phosphate, trifluoroethyl methyl butyl phosphate, pentafluoropropyl methyl butyl phosphate, heptafluorobutyl methyl butyl phosphate, trifluoroethyl diethyl phosphate, pentafluoropropyl diethyl phosphate, heptafluorobutyl diethyl phosphate, trifluoroethyl ethyl propyl phosphate, pentafluoropropyl ethyl propyl phosphate, heptafluorobutyl ethyl propyl phosphate, trifluoroethyl ethyl butyl phosphate, pentafluoropropyl ethyl butyl phosphate, heptafluorobutyl ethyl butyl phosphate, trifluoroethyl dipropyl phosphate, pentafluoropropyl dipropyl phosphate, heptafluorobutyl dipropyl phosphate, trifluoroethyl propyl butyl phosphate, pentafluoropropyl propyl butyl phosphate, heptafluorobutyl propyl butyl phosphate, trifluoroethyl dibutyl phosphate, pentafluoropropyl dibutyl phosphate, heptafluorobutyl dibutyl phosphate, tris(2,2,3,3-tetrafluoropropyl) phosphate, tris(2,2,3,3,3-pentafluoropropyl) phosphate, tris(2,2,2-trifluoroethyl) phosphate, tris(1H,1H-heptafluorobutyl) phosphate, tris(1H,1H,5H-octafluoropentyl) phosphate and the like.

Among these, fluorine containing phosphate ester compounds denoted by the formula (4) are preferable because of being high in the effect of suppressing the decomposition of the electrolyte solution at high potentials,

O═P(—O—R₄′)₃ (4)

wherein R₄′ is preferably a fluorine containing alkyl group having 1 to 5 carbon atoms.

Preferable fluorine containing phosphate ester compounds denoted by the formula (4) include tris(2,2,2-trifluoroethyl) phosphate, tris(2,2,3,3,3-pentafluoropropyl) phosphate, and tris(1H,1H-heptafluorobutyl) phosphate. Tris(2,2,2-trifluoroethyl) phosphate is particularly preferable.

The fluorine containing phosphate ester compounds may be used in alone or in combination of two or more. By comprising two or more kinds of the fluorine containing phosphate ester compounds, a secondary battery having excellent cycle characteristics may be obtained in some cases.

The fluorine containing phosphate ester compound has an advantage in that it has high oxidation resistance and is difficult to decompose. In addition, it is considered that it has the effect of suppressing gas generation. On the other hand, since the fluorine containing phosphate ester compound has high viscosity and comparatively low conductivity, when the content is too large, conductivity of the electrolyte solution is lowered. The content in the electrolyte solution is preferably 1 to 80% by volume, more preferably 5 to 70% by volume, and still more preferably 10 to 60% by volume. When the electrolyte solution comprises the fluorine containing phosphate ester compound in an amount of 5% by volume or more, it is possible to enhance the compatibility between the fluorine containing ether compound and other solvents.

In the present embodiment, the electrolyte solution preferably comprises at least one selected from sulfone compounds denoted by the formula (3),

R₁″—SO₂—R₂″ (3)

wherein R₁″ and R₂″ are a substituted or non-substituted alkyl group or alkylene group, wherein when R₁″ and R₂″ are an alkylene group, the sulfone compound denoted by the formula (3) is a cyclic compound in which carbon atoms of R₁″ and R₂″ are bonded through a single bond or a double bond.

In the formula (3), n1 that is the number of carbon atoms of R₁″ and n2 that is the number of carbon atoms of R₂″ are preferably, each independently, satisfy 1≤n1≤12 and 1≤n2≤12, more preferably 1≤n1≤6 and 1≤n2≤6, and still more preferably 1≤n1≤3 and 1≤n2≤3. In addition, the alkyl group includes open chain, branched and cyclic ones.

R₁″ and R₂″ may have a substituent. Examples of the substituent include alkyl group having 1 to 6 carbon atoms (e.g, methyl group, ethyl group, propyl group, isopropyl group, butyl group, isobutyl group), aryl group having 6 to 10 carbon atoms (e.g., phenyl group, naphthyl group), halogen atom (e.g., chlorine atom, bromine atom, fluorine atom) and the like.

The cyclic sulfone compounds may be also represented by the following formula (5).

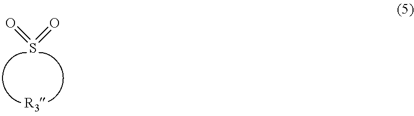

(In the formula (5), R₃″ represents a substituted or non-substituted alkylene group.)

In the formula (5), the number of carbon atoms of R₃″ is preferably 3 to 9, and more preferably 3 to 6.

R₃″ may have a substituent. Examples of the substituent include alkyl group having 1 to 6 carbon atoms (e.g, methyl group, ethyl group, propyl group, isopropyl group, butyl group), halogen atom (e.g., chlorine atom, bromine atom, fluorine atom) and the like.

Preferable examples of the sulfone compound include at least one selected from cyclic sulfones including sulfolane (i.e. tetramethylene sulfone), methylsulfolanes such as 3-methylsulfolane, 3,4-dimethylsulfolane, 2,4-dimethylsulfolane, trimethylene sulfone (thietane 1,1-dioxide), 1-methyl trimethylene sulfone, pentamethylene sulfone, hexamethylene sulfone and ethylene sulfone; and open-chain sulfones including dimethyl sulfone, ethyl methyl sulfone, diethyl sulfone, butyl methyl sulfone, dibutyl sulfone, methyl isopropyl sulfone, diisopropyl sulfone, methyl tert-butyl sulfone, butyl ethyl sulfone, butyl propyl sulfone, butyl isopropyl sulfone, di-tert-butyl sulfone, diisobutyl sulfone, ethyl isopropyl sulfone, ethyl isobutyl sulfone, tert-butyl ethyl sulfone, propyl ethyl sulfone, isobutyl isopropyl sulfone, butyl isobutyl sulfone and isopropyl (1-methyl-propyl) sulfone.

These sulfone compounds may be used singly or in combination of two or more thereof. In addition, as one aspect of the present embodiment, it is possible to use in combination of a cyclic sulfone compound and an open-chain sulfone compound.

The sulfone compounds have characteristics that the dielectric constant is comparatively high, facilitate dissociation of the electrolyte supporting salt and has the effect of increasing electrical conductivity of the electrolyte solution. Also, it has characteristics that oxidation resistance is high and gas is less generated even at a high temperature operation. On the other hand, since a sulfone compound has high viscosity, if the concentration thereof is excessively high, it is a problem that ion conductivity conversely decreases. For these reasons, the content of the sulfone compound in the non-aqueous electrolyte solution is preferably 1 to 80% by volume, more preferably 2 to 70% by volume, and further preferably 5 to 60% by volume. When the sulfone compound in the electrolyte solution is contained in an amount of 5% by volume or more, the compatibility between the fluorine-containing ether compound and other solvents can be enhanced.

The non-aqueous electrolyte solution may further comprise cyclic carbonates (including fluorides).

Examples of the cyclic carbonate, but are not particularly limited to, include ethylene carbonate (EC), propylene carbonate (PC), butylene carbonate (BC), vinylene carbonate (VC) and the like. Examples of the fluorinated cyclic carbonate include compounds in which a part or all of the hydrogen atoms in ethylene carbonate (EC), propylene carbonate (PC), butylene carbonate (BC), vinylene carbonate (VC) and the like are substituted with fluorine atoms. More specifically, for example, 4-fluoro-1,3-dioxolan-2-one (monofluoroethylene carbonate), (cis or trans)4,5-difluoro-1,3-dioxolan-2-one, 4,4-difluoro-1,3-dioxolan-2-one, 4-fluoro-5-methyl-1,3-dioxolan-2-one and the like may be used. Among the cyclic carbonates listed above, ethylene carbonate, propylene carbonate, 4-fluoro-1,3-dioxolan-2-one and the like are preferable from the viewpoint of voltage resistance and electrical conductivity. The cyclic carbonates may be used singly or in combination of two or more thereof.

The fluorine containing ether compound has low compatibility with other electrolyte solvents, and when the concentration is excessively high, it may be difficult in some cases to obtain a uniform electrolyte solution. However, among the cyclic carbonates, particularly when propylene carbonate is used, solubility increases, and thus the electrolyte solution preferably comprises propylene carbonate. It is preferable in some cases to comprise propylene carbonate in an amount of 20% by volume or more and 80% by volume or less in the total cyclic carbonate compounds used in the electrolyte solution. In one aspect of the present embodiment, the electrolyte solution preferably comprises at least one selected from the group consisting of propylene carbonate, ethylene carbonate and fluorinated ethylene carbonate, and among these, it is more preferable that propylene carbonate is contained in an amount of 20% by volume or more and 80% by volume or less in all the cyclic carbonate compounds.

Since the cyclic carbonate has a large relative dielectric constant, when the electrolyte solution comprises the cyclic carbonate, the dissolution of the supporting salt is enhanced and sufficient electrical conductivity can be easily imparted. When the electrolyte solution comprises a cyclic carbonate, it has the advantage that the ion mobility in the electrolyte solution is enhanced. However, under high voltage or high temperature, the electrolyte solution comprising the cyclic carbonate tends to generate a large amount of gas compared to the fluorine containing ether compounds, the fluorine containing phosphate ester compounds and the sulfone-compounds. On the other hand, the cyclic carbonate also has the effect of improving the cycle characteristics of the secondary battery due to film formation on the negative electrode. Thus, from the viewpoint of the effect of increasing dissociation degree of the supporting salt and the effect of increasing the electrical conductivity, the content of the cyclic carbonate in the non-aqueous electrolyte solution is preferably 1 to 70% by volume, more preferably 2 to 60% by volume and further preferably 5 to 50% by volume.

The non-aqueous electrolyte solution may further comprise open-chain carbonates (including fluoride), open-chain or cyclic carboxylic esters (including fluoride), cyclic ethers (including fluoride), phosphate esters (not including fluoride) and the like in addition to the above non-aqueous solvents.

Examples of the open-chain carbonate include, but are not particularly limited to, dimethyl carbonate (DMC), ethylmethyl carbonate (EMC), diethyl carbonate (DEC), dipropyl carbonate (DPC) and the like. The open-chain carbonate also includes a fluorinated open-chain carbonate. Examples of the fluorinated open-chain carbonate include compounds in which a part or all of hydrogen atoms in ethylmethyl carbonate (EMC), dimethyl carbonate (DMC), diethyl carbonate (DEC), dipropyl carbonate (DPC) and the like are substituted with fluorine atoms. As the open-chain fluorinated carbonate, more specifically, bis(fluoroethyl) carbonate, 3-fluoropropyl methyl carbonate, 3,3,3-trifluoropropyl methyl carbonate and the like may be exemplified. Among these, dimethyl carbonate is preferred from the viewpoint of voltage resistance and electrical conductivity. The open-chain carbonates may be used singly or in combination of two or more thereof.

The open-chain carbonate has the effect of reducing the viscosity of the electrolyte solution, and thus, it can increase the electrical conductivity of the electrolyte solution.

Examples of the open-chain carboxylic ester include, but are not particularly limited to, ethyl acetate, methyl propionate, ethyl formate, ethyl propionate, methyl butyrate, ethyl butyrate, methyl acetate, and methyl formate. The carboxylic esters also include fluorinated carboxylic esters, and examples of the fluorinated carboxylic ester include compounds in which a part or all of hydrogen atoms of ethyl acetate, methyl propionate, ethyl formate, ethyl propionate, methyl butyrate, ethyl butyrate, methyl acetate, or methyl formate are substituted with fluorine atoms. Specific examples thereof include ethyl pentafluoropropionate, ethyl 3,3,3-trifluoropropionate, methyl 2,2,3,3-tetrafluoropropionate, 2,2-difluoroethyl acetate, methyl heptafluoroisobutyrate, methyl 2,3,3,3-tetrafluoropropionate, methyl pentafluoropropionate, methyl 2-(trifluoromethyl)-3,3,3-trifluoropropionate, ethyl heptafluorobutyrate, methyl 3,3,3-trifluoropropionate, 2,2,2-trifluoroethyl acetate, isopropyl trifluoroacetate, tert-butyl trifluoroacetate, ethyl 4,4,4-trifluorobutyrate, methyl 4,4,4-trifluorobutyrate, butyl 2,2-difluoroacetate, ethyl difluoroacetate, n-butyl trifluoroacetate, 2,2,3,3-tetrafluoropropyl acetate, ethyl 3-(trifluoromethyl)butyrate, methyl tetrafluoro-2-(methoxy)propionate, 3,3,3trifluoropropyl 3,3,3-trifluoropropionate, methyl difluoroacetate, 2,2,3,3-tetrafluoropropyl trifluoroacetate, 1H,1H-heptafluorobutyl acetate, methyl heptafluorobutyrate, and ethyl trifluoroacetate. Among these, from the viewpoint of voltage resistance, the boiling point and the like, ethyl propionate, methyl acetate, methyl 2,2,3,3-tetrafluoropropionate, 2,2,3,3-tetrafluoropropyl trifluoroacetate and the like are preferable. The carboxylic ester is effective in reducing the viscosity of the electrolyte solution in the same way as the open-chain carbonate and the open-chain ether. Therefore, for example, the open-chain carboxylic ester may be used instead of the open-chain carbonate, and may also be used in combination with the open-chain carbonate.

The cyclic carboxylic ester is not particularly limited but examples thereof preferably include γ-lactones such as γ-butyrolactone, α-methyl-γ-butyrolactone and 3-methyl-γ-butyrolactone, β-propiolactone, δ-valerolactone, and the like. The fluoride compounds of these may be used.

Examples of the cyclic ethers include, but are not particularly limited to, tetrahydrofuran, 2-methyltetrahydrofuran, 1,3-dioxolane, 2-methyl-1,3-dioxolane and the like. 2,2-bis(trifluoromethyl)-1,3-dioxolane, 2-(trifluoroethyl) dioxolane and the like, which are partially fluorinated, may be used.

Examples of the phosphate esters include trimethyl phosphate, triethyl phosphate, tributyl phosphate and the like.

The non-aqueous electrolyte solution may contain the followings in addition to the above. The non-aqueous electrolyte solution may contain aprotic organic solvents including a non-fluorinated open-chain ethers such as 1,2-ethoxyethane (DEE) or ethoxymethoxyethane (EME), dimethyl sulfoxide, formamide, acetamide, dimethylformamide, acetonitrile, propionitrile, nitromethane, ethyl monoglyme, trimethoxymethane, dioxolane derivatives, 1,3-dimethyl-2-imidazolidinone, 3-methyl-2-oxazolidinone, propylene carbonate derivatives, tetrahydrofuran derivatives, ethyl ether, 1,3-propane sultone, anisole, N-methylpyrrolidone and the like.

Examples of the supporting salt include lithium salts such as LiPF₆, LiAsF₆, LiAlCl₄, LiClO₄, LiBF₄, LiSbbF₆, LiCF₃SO₃, LiC₄F₉SO₃, LiC(CF₃SO₂)₃, LiN(CF₃SO₂)₂, LiN(C₂F₅SO₂)₂, and LiB₁₀Cl₁₀. In addition, examples of other supporting salts include lithium lower aliphatic carboxylates, chloroborane lithium, lithium tetraphenylborate, LiBr, LiI, LiSCN, and LiCl. One supporting salt may be used alone, or two or more supporting salts may be used in combination. The concentration of the supporting salt in the electrolyte solution is preferably in the range of 0.3 mol/l or more and 5 mol/l or less.

An ion-conducting polymer may be added to the non-aqueous electrolyte solution. Examples of the ion-conducting polymer include polyethers such as polyethylene oxide and polypropylene oxide, and polyolefins such as polyethylene and polypropylene. In addition, examples of other ion-conducting polymer include polyvinylidene fluoride, polytetrafluoroethylene, polyvinyl fluoride, polyvinyl chloride, polyvinylidene chloride, polymethyl methacrylate, polymethyl acrylate, polyvinyl alcohol, polymethacrylonitrile, polyvinyl acetate, polyvinylpyrrolidone, polycarbonate, polyethylene terephthalate, polyhexamethylene adipamide, polycaprolactam, polyurethane, polyethylenimine, polybutadiene, polystyrene or polyisoprene, or derivatives thereof. One ion-conducting polymer may be used alone, or two or more ion-conducting polymers may be used in combination. In addition, polymers comprising various monomers forming the above polymers may be used.

Further, an electrolyte additive may be added to the non-aqueous electrolyte solution. Examples of the additive include 1,3-propane sultone, cyclic disulfone compounds, nitrile materials, boron materials and the like.

Secondary batteries excellent in cycle characteristics are obtained by using the electrolyte solution for secondary batteries according to the present embodiment to manufacture a secondary battery. Each constituting member of the battery suitable for the electrolyte solution for secondary batteries of the present invention will be described below but the constitution of the secondary battery except the electrolyte solution is not particularly limited.

### (Positive Electrode)

The positive electrode is formed, for example, by binding a positive electrode active material to a positive electrode current collector with a positive electrode binder. The positive electrode materials (positive electrode active materials) include, although it is not particularly limited to, spinel materials, layered materials and olivine-based materials.

As the spinel material,

LiMn₂O₄;

materials that operate at around 4V versus lithium in which lifetime is increased by substituting a part of Mn in LiMn₂O₄, for example,

LiMn₂₋ₓMₓO₄

(0<x<0.3, M is a metal element and comprises at least one selected from Li, Al, B, Mg, Si, and transition metals.);

materials that operate at high voltage around 5 V such as LiNi_{0.5}Mn_{1.5}O₄;

materials chargeable and dischargeable at a high potential having a similar composition to LiNi_{0.5}Mn_{1.5}O₄, which are formed by substituting a part of the materials of LiMn₂O₄ with a transition metal, and materials in which other elements are further added to these, for example,

Liₐ(MₓMn_{2-x-y}Y_{y})(O_{4-w}Z_{w}) (6)

(0.4≤x≤1.2, 0≤y, x+y<2, 0≤a≤1.2, 0≤w≤1, M is transition metal element(s) and comprises at least one selected from the group consisting of Co, Ni, Fe, Cr and Cu, Y is metal element(s) and comprises at least one selected from the group consisting of Li, B, Na, Al, Mg, Ti, Si, K and Ca, and Z is at least one selected from the group consisting of F and Cl.); and the like may be used.

In the formula (6), M comprises transition metal element(s) selected from the group consisting of Co, Ni, Fe, Cr and Cu, and the content of these metal elements in compositional ratio x is preferably 80% or more, more preferably 90% or more, and may be 100%. Y comprises metal element(s) selected from the group consisting of Li, B, Na, Al, Mg, Ti, Si, K and Ca, and the content of these metal elements in compositional ratio y is preferably 80% or more, more preferably 90% or more, and may be 100%.

The layered material is represented by the general formula of LiMO₂ (M is a metal element), and specific examples include lithium metal composite oxides having a layered structure represented by:

LiCo₁₋ₓMₓO₂

(0≤x<0.3, and M is a metal other than Co.);

Li_{y}Ni₁₋ₓMₓO₂ (A)

(0≤x<1, 0<y≤1.20, M is at least one element selected form the group consisting of Co, Al, Mn, Fe, Ti and B.), in particular,

LiNi₁₋ₓMₓO₂

(0.05<x<0.3, M is at least one metal element selected from Co, Mn and Al.);

Li(LiₓM_{1-x-z}Mn_{z})O₂ (7)

(0.1≤x<0.3, 0.33≤z≤0.7, M is at least one of Co and Ni.); and

Li(M_{1-z}Mn_{z})O₂

(0.33≤z≤0.8 and M is at least one of Li, Co and Ni.).

In the above formula (A), it is preferred that the content of Ni is high, that is, x is less than 0.5, further preferably 0.4 or less. Examples of such compounds include Li_{α}Ni_{β}Co_{γ}Mn_{δ}O₂ (1≤α≤1.2, β+γ+δ=1, β≥0.6, and γ≤0.2) and Li_{α}Ni_{β}Co_{γ}Al_{δ}O₂ (1≤α≤1.2, β+γ+δ=1, β≥0.6, and γ≤0.2) and particularly include LiNi_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, LiNi_{0.8}Co_{0.1}Al_{0.1}O₂, LiNi_{0.6}Co_{0.2}Mn_{0.2}O₂ and the like may be preferably used.

From the viewpoint of thermal stability, it is also preferred that the content of Ni does not exceed 0.5, that is, x is 0.5 or more in the formula (A). In addition, it is also preferred that particular transition metals do not exceed half. Examples of such compounds include Li_{α}Ni_{β}Co_{γ}Mn_{δ}O₂ (1≤α≤1.2, β+γ+δ=1, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.8}Co_{0.2}Mn_{0.3}O₂ (abbreviated as NCM523), LiNi_{0.8}Co_{0.3}Mn_{0.2}O₂ (abbreviated as NCM532), and LiNi_{0.4}Mn_{0.4}Co_{0.2}O₂ (also including those in which the content of each transition metal fluctuates by about 10% in these compounds).

In addition, two or more compounds represented by the formula (A) may be mixed and used, and, for example, it is also preferred that NCM532 or NCM523 and NCM433 are mixed in the range of 9:1 to 1:9 (as a typical example, 2:1) and used. Further, by mixing a material in which the content of Ni is high (x is 0.4 or less in the formula (A)) and a material in which the content of Ni does not exceed 0.5 (x is 0.5 or more, for example, NCM433), a battery having high capacity and high thermal stability can also be formed.

Li(Li_{0.2}Ni_{0.2}Mn_{0.6})O₂, Li(Li_{0.15}Ni_{0.3}Mn_{0.55})O₂, Li(Li_{0.15}Ni_{0.2}Co_{0.1}Mn_{0.55})O₂, Li(Li_{0.15}Ni_{0.15}Co_{0.15}Mn_{0.55})O₂, Li(Li_{0.15}Ni_{0.1}Co_{0.2}Mn_{0.55})O₂ and the like are preferred in the above formula, Li(LiₓM_{1-x-z}Mn_{z})O₂.

The olivine-type material is represented by the following general formula.

LiMPO₄,

(M is at least one of Co, Fe, Mn and Ni.)

Specifically, LiFePO₄, LiMnPO₄, LiCoPO₄, LiNiPO₄ and the like may be exemplified, and a part thereof may be substituted with another element or the oxygen part thereof may be substituted with fluorine. A positive electrode material operating at high potential of 4.5 V or higher versus lithium can be formed by comprising at least one of Co and Ni in M in the above LiMPO₄, and thereby the energy density of the battery becomes high. For this reason, Co and/or Ni preferably occupy 80% or more of the composition ratio in M, and materials denoted by the following general formula (8) is especially preferred.

LiMPO₄ (8)

(M is at least one of Co and Ni.)

Beside these, NASICON type, Lithium transition metal silicon composite oxides or the like may be used as the positive electrode materials. The positive electrode active material may be used alone or two or more thereof may be used in combination.

Among these positive electrodes, tpositive electrode materials operating at a high potential of 4.5 V or higher versus lithium are expected to show the effect of enhancing the energy density of batteries. For this reason, the positive electrode active materials of the general formulae (6), (7) and (8) are especially preferred.

The positive electrode active material has a specific surface area of, for example, from 0.01 to 10 m²/g, preferably from 0.05 to 8 m²/g, more preferably from 0.1 to 5 m²/g, and still more preferably from 0.15 to 4 m²/g. A specific surface area in such ranges makes it possible to adjust the area in contact with the electrolyte solution within an appropriate range. That is, a specific surface area of 0.01 m²/g or more can facilitate smooth insertion and desorption of lithium ions and further decrease the resistance. Alternatively, a specific surface area of 5 m²/g or less can further suppress promotion of decomposition of electrolyte solution and elution of the constituent elements of the active material.

The median particle size of the lithium metal composite oxide is preferably from 0.01 to 50 μm and more preferably from 0.02 to 40 μm. A particle size of 0.01 μm or more can further suppress elution of constituent elements of the positive electrode materials and also further suppress deterioration due to contact with the electrolyte solution. In contrast, a particle size of 50 μm or less can facilitate smooth insertion and desorption of lithium ions and further decrease the resistance. The particle size can be measured with a laser diffraction-scattering particle size distribution analyzer.

Examples of the binder for a positive electrode include, but are not limited to, polyvinylidene fluoride (PVdF), vinylidene fluoridehexafluoropropylene copolymer, vinylidene fluoride-tetrafluoroethylene copolymer, styrene-butadiene copolymer rubber, polytetrafluoroethylene, polypropylene, polyethylene, polyimide and polyamideimide. Among these, from the viewpoint of versatility and low cost, polyvinylidene fluoride is preferable. From the viewpoint of a trade-off relationship between “sufficient binding force” and “high energy density”, the amount of the binder used for positive electrode is preferably 2 to 10 parts by mass based on 100 parts by mass of the positive electrode active material.

Examples of the positive electrode current collector include, but are not limited to, aluminum, nickel, silver, and alloys thereof. Their shape includes foil, plate-like and mesh-like.

A conductive assistant may be added to the positive electrode active material layer containing the positive electrode active material in order to reduce impedance. The conductive assistant includes a carbonaceous microparticle such as graphite, carbon black, and acetylene black.

(Negative Electrode)

Examples of a negative electrode active material include, but are not particularly limited to, (a) carbon materials that can absorb and desorb lithium ions, (b) metals that can be alloyed with lithium, (c) metal oxides that can absorb and desorb lithium ions and the like.

As a carbon material (a), graphite, amorphous carbon, diamond-like carbon, a carbon nanotube, or composite thereof can be used. Highly crystalline graphite has high electrical conductivity and is excellent in adhesion to a negative electrode current collector made of a metal such as copper and in voltage flatness. On the other hand, amorphous carbons having a low crystallinity exhibit relatively small volume expansion, and therefore have effect of highly relaxing the volume expansion of the whole negative electrode, and hardly undergo the degradation due to nonuniformity such as crystal grain boundaries and defects. The carbon material (a) can be used be used singly or together with another active material.

As the metal (b), metals mainly composed of Al, Si, Pb, Sn, Zn, Cd, Sb, In, Bi, Ag, Ba, Ca, Hg, Pd, Pt, Te, or La; or an alloy containing two or more of the above metals; or an alloy of lithium with the above metals or alloys and the like can be used. In particular, it is preferred to contain silicon (Si) as the metal (b). The metal (b) can be used singly or together with another active material.

As the metal oxide (c), silicon oxide (for example, SiO, SiO₂ and the like), aluminum oxide, tin oxide (for example, SnO, SnO₂ and the like), indium oxide, zinc oxide, lithium oxide, LiFe₂O₃, WO₂, MoO₂, CuO, Nb₃O₅, LiₓTi₂₋ₓO₄ (1≤x≤4/3), PbO₂, Pb₂O₅, or a composite containing two or more of these oxides can be used. Especially, it is preferable to contain silicon oxide as the metal oxide (c). This is because silicon oxide is relatively stable and is hard to trigger a reaction with other compounds. Moreover, one or more of elements selected from nitrogen, boron and sulfur may also be added to the metal oxide (c) in an amount of, for example, 0.1 to 5 mass %. Thereby, electrical conductivity of the metal oxide (c) can be raised.

Among combinations of the above positive electrode materials, it is preferable to use the carbon negative electrode materials such as graphite and the Si based negative electrode materials such as Si, Si alloys and Si oxides. This is because these materials are suitable for increasing energy density of batteries. The graphite material and the Si based material can be mixed for use. The graphite materials are characterized by excellent cycle characteristics. In contrast, the Si based negative electrode materials are suitable for increasing energy density but expansion and contraction thereof are large at the time of insertion and desorption of Li and thereby electrical contact between active materials may be broken in some cases. The electrical contact can be maintained and cycle characteristics and high energy density can be compatible by mixing the graphite negative electrode materials and the Si based negative electrode materials. With respect to the mixing ratio of the Si based negative electrode materials such as Si, Si alloys and Si oxides and the carbon negative electrode materials such as graphite, the ratio of the mass of the Si based negative electrode materials to the total mass of both is preferably 0.5% or more and 95% or less, more preferably 1% or more and 50% or less, still more preferably 2% or more and 40% or less.

In addition, the negative electrode active materials may include, for example, a metal sulfide capable of absorbing and desorbing lithium ions. Examples of the metal sulfide include SnS and FeS₂. In addition, examples of the negative electrode active material may include metal lithium, polyacene or polythiophene, or lithium nitride such as Li₅(Li₃N), Li₇MnN₄, Li₃FeN₂, Li_{2.5}Co_{0.5}N, or Li₃CoN.

The above negative electrode active materials can be used alone or two or more thereof can be used in combination.

As these negative electrode active materials, particulate ones may be used or film type ones formed on the current collector by a vapor phase method or the like may be also used. From the viewpoint of industrial use, particulate ones are preferable.

The specific surface area of these negative electrode active materials is, for example, 0.01 to 100 m²/g, preferably 0.02 to 50 m²/g, more preferably 0.05 to 30 m²/g, and still more preferably 0.1 to 20 m²/g. When the specific surface area is set within such a range, a contact area with the electrolyte solution can be adjusted to a suitable range. That is, when the specific surface area is set to 0.01 m²/g or more, it becomes easy to perform intercalation and deintercalation of lithium ions smoothly and therefore resistance can be more reduced. Moreover, when the specific surface area is set to 20 m²/g or less, it is possible to more suppress progress of decomposition of the electrolyte solution and elution of a component element of the active material.

Examples of the binder for the negative electrode include, but are not limited to, polyvinylidene fluoride (PVdF), vinylidene fluoridehexafluoropropylene copolymer, vinylidene fluoride-tetrafluoroethylene copolymer, styrene-butadiene copolymer rubber, polytetrafluoroethylene, polypropylene, polyethylene, polyimide and polyamideimide.

The content of the negative electrode binder is preferably in the range of 0.1 to 30% by mass, more preferably 0.5 to 25% by mass, based on the total amount of the negative electrode active material and the negative electrode binder. By setting the content to 0.5% by mass or more, the adhesiveness between the active materials or between the active material and the current collector is improved, and the cycle characteristics become good. In addition, by setting the content to 30% by mass or less, the active material ratio is increased and thus the negative electrode capacity can be improved.

The negative electrode current collector is not particularly limited, but aluminum, nickel, copper, silver, iron, chromium and alloys thereof are preferred because of electrochemical stability. Examples of its shape include foil, a flat plate shape, and a mesh shape.

The negative electrode can be made by forming a negative electrode active material layer comprising the negative electrode active material and the binder for negative electrode on the negative electrode current collector. Examples of the method for forming the negative electrode active material layer include a doctor blade method, a die coater method, a CVD method, and a sputtering method. It is possible to previously form a negative electrode active material layer and then form a thin film of aluminum, nickel, or an alloy thereof by a method such as vapor deposition or sputtering to provide a negative electrode current collector.

(Separator)

The secondary battery may be constituted by a combination of a positive electrode, a negative electrode, a separator, and a non-aqueous electrolyte solution. Examples of the separator include woven fabrics, nonwoven fabrics, porous polymer films of polyolefins, such as polyethylene and polypropylene, polyimides and porous polyvinylidene fluoride films, and the like, or ion-conducting polymer electrolyte films. These may be used alone or in combination thereof. In addition, aramid resin separator may be also used. The aramid resin separator may be used in the form of nonwoven fabrics or microporous membrane.

(Shape of Battery)

Examples of the shape of the secondary battery include a cylindrical shape, a rectangular shape, a coin type, a button type, and a laminate type. Examples of the outer package of the battery include stainless, iron, aluminum, titanium, or alloys thereof, or plated articles thereof. As the plating, for example, nickel plating may be used.

Examples of the laminate resin film used in a laminate type include aluminum, aluminum alloy, stainless-steel and titanium foil. Examples of a material of the thermally bondable portion of the metal laminate resin film include thermoplastic polymer materials, such as polyethylene, polypropylene, and polyethylene terephthalate. In addition, each of the numbers of the metal laminate resin layers and the metal foil layers is not limited to one and may be two or more.

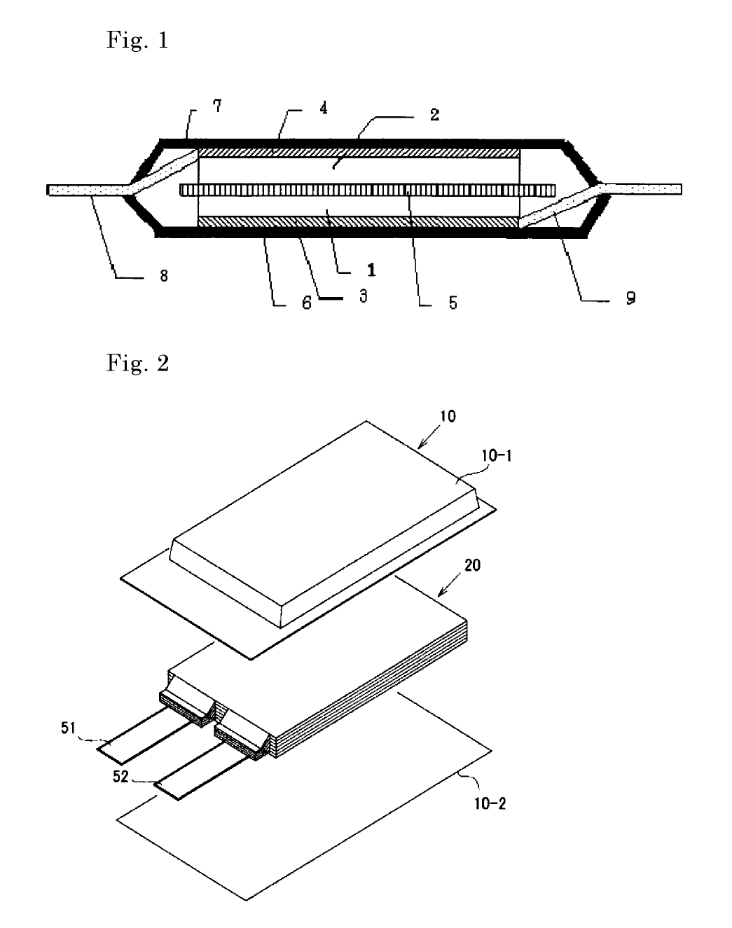

As shown in FIG. 1, a lithium secondary battery has: a positive electrode active material layer 1 containing a positive electrode active material on a positive electrode current collector 3 made of metal such as aluminium foil; and a negative electrode active material layer 2 containing a negative electrode active material on a negative electrode current collector 4 made of metal such as copper foil. The positive electrode active-material layer 1 and negative electrode active-material layer 2 are arranged so as to face each other interposing an electrolyte solution and a separator 5 made of nonwoven fabric, polypropylene microporous film and the like which contains the electrolyte solution. In FIG. 1, numerals 6 and 7 show an outer package, 8 shows a negative electrode tab, and 9 shows a positive electrode tab.

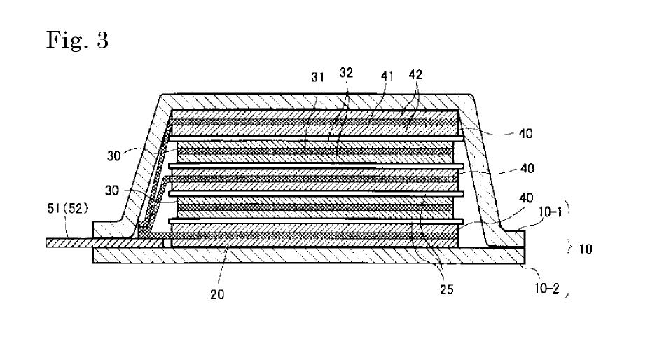

As another embodiment, a secondary battery having a structure as shown in FIG. 2 and FIG. 3 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 3. In the positive electrode 30, an electrode material 32 is applied to both surfaces of a metal foil 31, and also in the negative electrode 40, an electrode material 42 is applied to both surfaces of a metal foil 41 in the same manner.

In the secondary battery in FIG. 1, the electrode tabs are drawn out on both sides of the package, but a secondary battery of the present invention may have an arrangement in which the electrode tabs are drawn out on one side of the package as shown in FIG. 2. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 3). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 3, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 2 and FIG. 3, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

The lithium ion secondary battery according to the present embodiment can be manufactured in accordance with conventional methods, using an electrolyte solution comprising the fluorine containing ether compound and the fluorine containing phosphate ester compound and/or the sulfone compound, and lithium difluorophosphate. An example of a method for manufacturing a lithium ion secondary battery will be described as an example of a stacked lithium ion secondary battery. First, a negative electrode and a positive electrode are laminated via separator in a dry air or inert gas atmosphere to produce an electrode element. Next, the electrode element is housed in an outer package (container), and an electrolyte solution is injected to immerse the electrode element in the electrolyte solution. Then, the opening of the outer package is sealed to produce a lithium ion secondary battery.

### Example

Specific examples according to the present invention will be described below, but the present invention is not limited to these examples and can be carried out by making appropriate changes within the scope not exceeding its purpose. FIG. 1 is a schematic view illustrating the constitution of the lithium secondary battery fabricated in the present Examples.

LiNi_{0.5}Mn_{1.5}O₂ as a positive electrode active material, polyvinylidene fluoride as a binder (4 mass %), and carbon black as a conductive assistant (4 mass %) were mixed to prepare a positive electrode mixture. The positive electrode mixture was dispersed in N-methyl-2-pyrrolidone to prepare positive electrode slurry. The positive electrode slurry was uniformly applied onto one side of an aluminum current collector having a thickness of 20 μm. The thickness of the coating film was adjusted such that the initial charge capacity per unit area was 2.5 mAh/cm². After drying, the resultant was subjected to a compression-molding by a roll press to produce a positive electrode.

Artificial graphite was used as a negative electrode active material. The artificial graphite was dispersed in a N-methylpyrrolidone solution of PVDF to prepare negative electrode slurry. The mass ratio of the negative electrode active material and the binder was 90/10. The negative electrode slurry was uniformly applied onto a Cu current collector with a thickness of 10 μm. The thickness of the coating film was adjusted such that the initial charge capacity per unit area was 3.0 mAh/cm². After drying, the resultant was subjected to a compression-molding by a roll press to produce a negative electrode.

The positive electrode and the negative electrode, which were cut into 3 cm×3 cm, were disposed so as to be opposed to each other via a separator. For the separator, a microporous polypropylene film having a thickness of 25 μm was used.

A solution in which ethylene carbonate (EC) that is a cyclic carbonate, 1,1,2,2-tetrafluoroethyl 2,2,3,3-tetrafluoropropyl ether (FE1) that is a fluorine containing ether, and tris(2,2,2-trifluoroethyl) phosphate (FP1) that is a fluorine containing phosphate ester are mixed at a ratio of EC/FE1/FP1=30/40/30 (volume ratio) was used in a non-aqueous electrolyte solution. LiPF₆ was dissolved in this non-aqueous electrolyte solution at a concentration of 1.0 mol/l to prepare an electrolyte solution. Lithium difluorophosphate (LiPF₂O₂) was dissolved in this electrolyte solution in an amount shown in Table 1, to complete an electrolyte solution.

The above positive electrode, negative electrode, separator, and electrolyte solution were disposed in a laminate package, and the laminate was sealed to make a lithium secondary battery. The positive electrode and the negative electrode were brought into a state in which tabs were connected and the positive electrode and the negative electrode were electrically connected from the outside of the laminate.

(Cycle Characteristics)

The cell was disposed in a thermostat chamber at 45° C. in order to confirm the cycle characteristics under high temperature. The battery was charged at 20 mA. After the voltage reached an upper limit voltage of 4.75 V, the battery was charged at constant voltage until the entire charge time reached 2.5 hours. Then, the battery was discharged at 20 mA of a constant current until the voltage reached a lower limit voltage of 3 V. This charge and discharge was repeated 200 times. The ratio of a capacity at the 200th cycle to a capacity at the 1st cycle was evaluated as a capacity retention ratio after 200 cycles at 45° C. The results are shown in Table 1.

TABLE 1

| | | | | Addition | |
|---|---|---|---|---|---|
| | | | | amount | |
| | Positive | Negative | Range of | of | Capacity |
| | electrode | electrode | operating | LiPF₂O₂ | retention |
| | material | material | voltage | [wt %] | ratio |
| Comparative | LiNi_{0.5}Mn_{1.5}O₄ | Graphite | 4.75 to 3 V | 0 | 72% |
| example 1 | | | | | |
| Example 1 | LiNi_{0.5}Mn_{1.5}O₄ | Graphite | 4.75 to 3 V | 0.05 | 75% |
| Example 2 | LiNi_{0.5}Mn_{1.5}O₄ | Graphite | 4.75 to 3 V | 0.2 | 78% |
| Example 3 | LiNi_{0.5}Mn_{1.5}O₄ | Graphite | 4.75 to 3 V | 0.5 | 83% |
| Example 4 | LiNi_{0.5}Mn_{1.5}O₄ | Graphite | 4.75 to 3 V | 1 | 79% |
| Example 5 | LiNi_{0.5}Mn_{1.5}O₄ | Graphite | 4.75 to 3 V | 2 | 77% |
| Example 6 | LiNi_{0.5}Mn_{1.5}O₄ | Graphite | 4.75 to 3 V | 3 | 74% |

The capacity retention ratio after 200 cycles at 45° C. was increased by adding lithium difluorophosphate. The effect was confirmed at 0.05 mass % or more. The improvement effect was high around 0.2 mass % to 2 mass %.

The electrolyte solution was further investigated. Solutions, in which ethylene carbonate (EC) and propylene carbonate (PC) that are a cyclic carbonate, and diethyl carbonate (DEC), sulfolane (SL) that is a cyclic sulfone compound, 1,1,2,2-tetrafluoroethyl 2,2,3,3-tetrafluoropropyl ether (FE1) and 2,2,3,4,4,4-hexafluorobutyl difluoromethyl ether (FE2) that are a fluorine containing ether and tris(2,2,2-trifluoroethyl) phosphate (FP1) that is a fluorine containing phosphate were mixed at a volume ratio shown in Table 2, were respectively used in a non-aqueous electrolyte solution. LiPF₆ was dissolved in these non-aqueous electrolyte solutions at a concentration of 0.8 mol/l to prepare electrolyte solutions. Lithium difluorophosphate was dissolved in these electrolyte solutions to complete electrolyte solutions. With respect to the lithium ion secondary batteries manufactured in the same manner as in Example 1 using each electrolyte solution, results of the capacity retention ratios after 200 cycles at 45° C. are shown in Table 2.

TABLE 2

| | | Addition amount | Capacity |
|---|---|---|---|
| | | of LiPF₂O₂ | retention |
| | Composition of solvent | [wt %] | ratio |
| Comparative | EC/FP1/FE1 = 40/40/20 | 0 | 69% |
| example 2 | | | |
| Example 7 | EC/FP1/FE1 = 40/40/20 | 0.5 | 79% |
| Comparative | EC/FP1/FE2 = 20/40/40 | 0 | 72% |
| example 3 | | | |
| Example 8 | EC/FP1/FE2 =20/40/40 | 0.5 | 84% |
| Comparative | EC/PC/FP1/FE3 = 10/10/50/30 | 0 | 73% |
| example 4 | | | |
| Example 9 | EC/PC/FP1/FE3 = 10/10/50/30 | 0.5 | 80% |
| Comparative | EC/SL/FE1 = 30/20/50 | 0 | 71% |
| example 5 | | | |
| Example 10 | EC/SL/FE1 = 30/20/50 | 0.5 | 82% |
| Comparative | EC/SL/FP1/FE1 = 10/10/30/50 | 0 | 74% |
| example 6 | | | |
| Example 11 | EC/SL/FP1/FE1 = 10/10/30/50 | 0.5 | 86% |
| Comparative | EC/DEC/FP1 = 30/40/30 | 0 | 72% |
| example 7 | | | |
| Comparative | EC/DEC/FP1 = 30/40/30 | 0.5 | 71% |
| example 8 | | | |
| Comparative | EC/DEC = 30/70 | 0 | 47% |
| example 9 | | | |
| Comparative | EC/DEC = 30/70 | 1 | 47% |
| example 10 | | | |

As shown in Table 2, in the electrolyte solution comprising a fluorine containing ether compound, and a fluorine containing phosphate ester compound and/or a sulfone compound, the capacity retention ratio was high and therefore the effect due to LiPF₂O₂ was high. It is considered that the decomposition reaction was suppressed at an interface between the high voltage positive electrode and the electrolyte solution by using the solvents with high oxidation resistance, and thereby the capacity retention ratio was increased. In addition, it is considered that the properties were improved by the effects due to adding LiPF₂O₂, such as film formation at a positive electrode interface. The improvement effect due to adding LiPF₂O₂ was higher in the electrolyte solution comprising a fluorine containing ether compound, and a fluorine containing phosphate ester compound and/or a sulfone compound than in the electrolyte solution not comprising a fluorine containing phosphate ester compound and a sulfone compound. It is considered that there is a possibility that film components tent to be produced and an excellent film comprising the solvent components were formed in the case of using these solvents.

Subsequently, composition and type of the sulfone solvent in the electrolyte solution were evaluated. As a sulfone compound, sulfolane (SL), 3-methylsulfolane (MSL), dimethyl sulfone (DMS), ethyl methyl sulfone (EMS), diethyl sulfone (DES), ethyl isopropyl sulfone (EiPS) were used. Cycle characteristics of butteries using the same positive electrode and negative electrode as in Example 1 and the electrolyte solution shown in Table 3 were evaluated in the same manner. The concentration of the supporting salt (LiPF₆) in the electrolyte solution was 1 mol/l. Table 3 shows results of the capacity retention ratios after 200 cycles at 45° C. of the lithium ion secondary batteries using each electrolyte solution and manufactured in the same way as in Example 1.

TABLE 3

| | | Addition amount | Capacity |
|---|---|---|---|
| | | of LiPF₂O₂ | retention |
| | Composition of solvent | [wt %] | ratio |
| Comparative | EC/SL/FE1 = 30/20/50 | 0 | 71% |
| example 11 | | | |
| Example 12 | EC/SL/FE1 = 30/20/50 | 0.5 | 82% |
| Comparative | EC/MSL/FE1 = 30/20/50 | 0 | 72% |
| example 12 | | | |
| Example 13 | EC/MSL/FE1 = 30/20/50 | 0.5 | 79% |
| Comparative | EC/DMS/FE1 = 30/20/50 | 0 | 76% |
| example 13 | | | |
| Example 14 | EC/DMS/FE1 = 30/20/50 | 0.5 | 83% |
| Comparative | EC/EMS/FE1 = 30/20/50 | 0 | 75% |
| example 14 | | | |
| Example 15 | EC/EMS/FE1 = 30/20/50 | 0.5 | 82% |
| Comparative | EC/EiPS/FE1 = 30/20/50 | 0 | 67% |
| example 15 | | | |
| Example 16 | EC/EiPS/FE1 = 30/20/50 | 0.5 | 76% |
| Comparative | EC/DES/FE1 = 30/20/50 | 0 | 73% |
| example 16 | | | |
| Example 17 | EC/DES/FE1 = 30/20/50 | 0.5 | 81% |

As shown in Table 3, the effect of adding LiPF₂O₂ can be seen in any electrolyte solution comprising a sulfone compound.

Subsequently, the evaluation was carried out by changing the fluorine containing ether compounds and the fluorine containing phosphate ester compounds. The compositions of the fluorine containing ether compound and the fluorine containing phosphate ester compound were changed as shown in Table 4 and the experiments were conducted in the same way as in Example 1. With respect to the fluorine containing ether compounds and the fluorine containing phosphate ester compounds shown in Table 4, the following compounds were used and the abbreviated names thereof are shown in the table. The concentration of the supporting salt (LiPF₆) in the electrolyte solution was 0.8 mol/l. Table 4 shows the results of the capacity retention ratios after 200 cycles at 45° C. of the lithium ion secondary batteries manufactured in the same way as Example 1 and using each electrolyte solution.
FE1: 1,1,2,2-tetrafluoroethyl 2,2,3,3-tetrafluoropropyl ether
FE2: 2,2,3,4,4,4-hexafluorobutyl difluoromethyl ether
FE3: 1,1-difluoroethyl 2,2,3,3-tetrafluoropropyl ether
FE4: 1,1,2,3,3,3-hexafluoropropyl 2,2-difluoroethyl ether
FE5: 1, 1-difluoroethyl 1H,1H-heptafluorobutyl ether
FE6: 1H,1H,2′H,3H-decafluorodipropyl ether
FE7: bis(2,2,3,3,3-pentafluoropropyl)ether
FE8: 1H, 1H,5H-perfluoropentyl 1,1,2,2-tetrafluoroethyl ether
FE9: bis(1H,1H-heptafluorobutyl)ether
FE10: 1H, 1H,2′H-perfluorodipropyl ether
FE11: 1,1,2,3,3,3-hexafluoropropyl 1H,1H-heptafluorobutyl ether
FE12: 1H-perfluorobutyl 1H-perfluoroethyl ether
FE13: bis(2,2,3,3-tetrafluoropropyl)ether
FP1: tris(2,2,2-trifluoroethyl) phosphate
FP2: tris(2,2,3,3,3-pentafluoropropyl) phosphate
FP3: tris(1H,1H-heptafluorobutyl) phosphate

TABLE 4

| | | Addition | |
|---|---|---|---|
| | | amount of | Capacity |
| | | LiPF₂O₂ | retention |
| | Composition of solvent | [wt %] | ratio |
| Comparative | EC/FP1/FE1 = 30/50/20 | 0 | 69% |
| example 17 | | | |
| Example 18 | EC/FP1/FE1 = 30/50/20 | 0.5 | 78% |
| Comparative | EC/FP1/FE2 = 30/50/20 | 0 | 66% |
| example 18 | | | |
| Example 19 | EC/FP1/FE2 = 30/50/20 | 0.5 | 77% |
| Comparative | EC/FP1/FE3 = 30/50/20 | 0 | 65% |
| example 19 | | | |
| Example 20 | EC/FP1/FE3 = 30/50/20 | 0.5 | 76% |
| Comparative | EC/FP1/FE4 = 30/50/20 | 0 | 68% |
| example 20 | | | |
| Example 21 | EC/FP1/FE4 = 30/50/20 | 0.5 | 79% |
| Comparative | EC/FP1/FE5 = 30/50/20 | 0 | 64% |
| example 21 | | | |
| Example 22 | EC/FP1/FE5 = 30/50/20 | 0.5 | 75% |
| Comparative | EC/FP1/FE6 = 30/50/20 | 0 | 67% |
| example 22 | | | |
| Example 23 | EC/FP1/FE6 = 30/50/20 | 0.5 | 77% |
| Comparative | EC/FP1/FE7 = 30/50/20 | 0 | 71% |
| example 23 | | | |
| Example 24 | EC/FP1/FE7 = 30/50/20 | 0.5 | 83% |
| Comparative | EC/FP1/FE8 = 30/50/20 | 0 | 67% |
| example 24 | | | |
| Example 25 | EC/FP1/FE8 = 30/50/20 | 0.5 | 75% |
| Comparative | EC/FP1/FE9 = 30/50/20 | 0 | 68% |
| example 25 | | | |
| Example 26 | EC/FP1/FE9 = 30/50/20 | 0.5 | 76% |
| Comparative | EC/FP1/FE10 = 30/50/20 | 0 | 66% |
| example 26 | | | |
| Example 27 | EC/FP1/FE10 = 30/50/20 | 0.5 | 74% |
| Comparative | EC/FP1/FE11 = 30/50/20 | 0 | 64% |
| example 27 | | | |
| Example 28 | EC/FP1/FE11 = 30/50/20 | 0.5 | 74% |
| Comparative | EC/FP1/FE12 = 30/50/20 | 0 | 65% |
| example 28 | | | |
| Example 29 | EC/FP1/FE12 = 30/50/20 | 0.5 | 76% |
| Comparative | EC/FP1/FE13 = 30/50/20 | 0 | 69% |
| example 29 | | | |
| Example 30 | EC/FP1/FE13 = 30/50/20 | 0.5 | 81% |
| Comparative | EC/FP1/FP2/FE1 = 30/30/20/20 | 0 | 62% |
| example 30 | | | |
| Example 31 | EC/FP1/FP2/FE1 = 30/30/20/20 | 0.5 | 73% |
| Comparative | EC/FP1/FP2/FE1 = 30/30/20/20 | 0 | 63% |
| example 31 | | | |
| Example 32 | EC/FP1/FP3/FE1 = 30/30/20/20 | 0.5 | 74% |

Even when the evaluation of various types of fluorine containing ether compounds and fluorine containing phosphate ester compounds was carried out as shown in Table 4, the effect was seen in any case. With respect to the fluorine-containing ether compound, the fluorination ratio is preferably 40% or more and 90% or less.

Subsequently, the evaluation was carried out by changing the positive electrode material. The evaluation was carried out by using LiNi_{0.45}Co_{0.1}Mn_{1.45}O₄ that is a 5V class spinel type, LiNi_{1/3}Co_{1/3}Mn_{1/3}O₂ that is a layered type, Li(Li_{0.2}Ni_{0.2}Mn_{0.6})O₂ that is a Li excess layered type, and LiCoPO₄ that is an olivine type. The positive electrode, the negative electrode and the electrolyte solution solvent were prepared under the same conditions as in Example 1. In the case of the positive electrode comprising Li(Li_{0.2}Ni_{0.2}Mn_{0.6})O₂ that is a Li excess layered type, SiO coated with carbon on the surface was used for the negative electrode active material. The mass ratio of SiO and carbon was 95/5. SiO was dispersed in a solution prepared by dissolving a polyimide binder in N-methylpyrrolidone to prepare negative electrode slurry. The mass ratio of the negative electrode active material and the binder was 85/15. The thickness of the coating film was adjusted such that the initial charge capacity per unit area was 3.0 mAh/cm², to prepare a negative electrode. The same cycle characteristics evaluation was carried out as in Example 1. For the charging voltage and discharging voltage in the evaluation of cycle characteristics, the values shown in Table 5 were used according to each positive and negative electrode material. Results of the capacity retention ratios after 200 cycles at 45° C. are shown in Table 5.

TABLE 5

| | | Negative | Range of | Addition amount | Capacity |
|---|---|---|---|---|---|
| | | electrode | operating | of LiPF₂O₂ | retention |
| | Positive electrode material | material | voltage | [wt %] | ratio |
| Comparative | LiNi_{0.45}Co_{0.1}Mn_{1.45}O₄ | Graphite | 4.75 to 3 V | 0 | 72% |
| example 32 | | | | | |
| Example 33 | LiNi_{0.45}Co_{0.1}Mn_{1.45}O₄ | Graphite | 4.75 to 3 V | 0.5 | 81% |
| Comparative | LiNi_{1/3}Co_{1/3}Mn_{1/3}O₂ | Graphite | 4.2 to 3 V | 0 | 89% |
| example 33 | | | | | |
| Example 34 | LiNi_{1/3}Co_{1/3}Mn_{1/3}O₂ | Graphite | 4.2 to 3 V | 0.5 | 90% |
| Comparative | Li(Ni_{0.2}Ni_{0.2}Mn_{0.6})O₂ | SiO | 4.6 to 2 V | 0 | 58% |
| example 34 | | | | | |
| Example 35 | Li(Li_{0.2}Ni_{0.2}Mn_{0.6})O₂ | SiO | 4.6 to 2 V | 0.5 | 67% |
| Comparative | LiCoPO₄ | Graphite | 4.8 to 3 V | 0 | 52% |
| example 35 | | | | | |
| Example 36 | LiCoPO₄ | Graphite | 4.8 to 3 V | 1 | 63% |

In the case of LiNi_{1/3}Co_{1/3}Mn_{1/3}O₂ in which charging was carried out at 4.2 V, the effect of lithium difluorophosphate was small. In contrast, in the case of other positive electrodes operable in a high potential, the improvement effect was great. It is considered that lithium difluorophosphate exerts a remarkable effect on a positive electrode material operable in a high potential of 4.5 V or higher.

As shown above, the improvement effect on cycle characteristics can be obtained by adopting the configuration of the present embodiment. Thereby, a long-life lithium battery can be provided.

### INDUSTRIAL APPLICABILITY

The battery according to the present invention can be utilized in, for example, all the industrial fields requiring a power supply and the industrial fields pertaining to the transportation, storage and supply of electric energy. Specifically, it can be used in, for example, power supplies for mobile equipment such as cellular phones and notebook personal computers; power supplies for electrically driven vehicles including an electric vehicle, a hybrid vehicle, an electric motorbike and an electric-assisted bike, and moving/transporting media such as trains, satellites and submarines; backup power supplies for UPSs; and electricity storage facilities for storing electric power generated by photovoltaic power generation, wind power generation and the like.

### APPENDIX

The following aspects are also preferred in the present embodiment.

### APPENDIX 1

An electrolyte solution for secondary batteries, wherein the electrolyte solution comprises at least one cyclic carbonate selected from ethylene carbonate, propylene carbonate, and fluorinated ethylene carbonate.

### APPENDIX 2

An electrolyte solution for secondary batteries according to the Appendix 1, wherein the electrolyte solution comprises the cyclic carbonate compound in an amount of 2 volume % or more and 50 volume % or less.

### EXPLANATION OF REFERENCE

1 positive electrode active material layer
2 negative electrode active material layer
3 positive electrode current collector
4 negative electrode current collector
5 separator
6 laminate outer package
7 laminate outer package
8 negative electrode tab
9 positive electrode tab
10 film package
20 battery element
25 separator
30 positive electrode
40 negative electrode

1. An electrolyte solution for secondary batteries comprising
at least one selected from fluorine containing ether compounds denoted by formula (1),
at least one selected from fluorine containing phosphate ester compounds denoted by formula (2) and sulfone compounds denoted by formula (3), and
a lithium difluorophosphate,
R₁—O—R₂ (1)
wherein R₁ and R₂ are each independently an alkyl group or a fluorine containing alkyl group, and at least one of R₁ and R₂ is a fluorine containing alkyl group,
O═P(—O—R₁′)(—O—R₂′)(—O—R₃′) (2)
wherein R₁′, R₂′ and R₃′ are each independently an alkyl group or a fluorine containing alkyl group, and at least one of R₁′, R₂′ and R₃′ is a fluorine containing alkyl group,
R₁″—SO₂—R₂″ (3)
wherein R₁″ and R₂″ are a substituted or non-substituted alkyl group or alkylene group, wherein when R₁″ and R₂″ are an alkylene group, the sulfone compound denoted by the formula (3) is a cyclic compound in which carbon atoms of R₁″ and R₂″ are bonded through a single bond or a double bond.

2. The electrolyte solution for secondary batteries according to claim 1, wherein a concentration of the lithium difluorophosphate in the electrolyte solution is 0.05 mass % or more and 10 mass % or less.

3. The electrolyte solution for secondary batteries according to claim 1, wherein a concentration of the fluorine containing ether compound denoted by formula (1) is 10 volume % or more and 90 volume % or less.

4. The electrolyte solution for secondary batteries according to claim 1, wherein a ratio of the number of fluorine atoms to the total number of hydrogen atoms and fluorine atoms in R₁ and R₂ of the fluorine containing ether compound denoted by formula (1) is 40% or more and 90% or less.

5. The electrolyte solution for secondary batteries according to claim 1, wherein the fluorine containing ether compound denoted by formula (1) is at least one selected from 1,1,2,2-tetrafluoroethyl 2,2,3,3-tetrafluoropropyl ether, 2,2,3,4,4,4-hexafluorobutyl difluoromethyl ether, 1,1-difluoroethyl 2,2,3,3-tetrafluoropropyl ether, 1,1,2,3,3,3-hexafluoropropyl 2,2-difluoroethyl ether, 1,1-difluoroethyl 1H, 1H-heptafluorobutyl ether, 1H,1H,2′H,3H-decafluorodipropyl ether, bis(2,2,3,3,3-pentafluoropropyl) ether, 1H,1H,5H-perfluoropentyl 1,1,2,2-tetrafluoroethyl ether, bis(1H,1H-heptafluorobutyl) ether, 1H,1H,2′H-perfluorodipropyl ether, 1,1,2,3,3,3-hexafluoropropyl-1H,1H-heptafluorobutyl ether, 1H-perfluorobutyl-1H-perfluoroethyl ether, bis(2,2,3,3-tetrafluoropropyl) ether.

6. The electrolyte solution for secondary batteries according to claim 1, comprising the fluorine containing phosphate ester compound denoted by formula (2) and the sulfone compound denoted by formula (3), wherein a volume ratio of the fluorine containing phosphate ester compound denoted by formula (2) and the sulfone compound denoted by formula (3) in the electrolyte solution is 5 volume % or more and 80 volume % or less.

7. The electrolyte solution for secondary batteries according to claim 1, comprising at least one of the fluorine containing phosphate ester compound denoted by formula (2) selected from tris(2,2,2-trifluoroethyl) phosphate, tris(2,2,3,3,3-pentafluoropropyl) phosphate, and tris(1H,1H-heptafluorobutyl) phosphate.

8. The electrolyte solution for secondary batteries according to claim 1, comprising at least one of the sulfone compound denoted by formula (3) selected from sulfolane, 3-methylsulfolane, dimethyl sulfone, ethyl methyl sulfone, diethyl sulfone, and ethyl isopropyl sulfone.

9. A secondary battery comprising the electrolyte solution for secondary batteries according to claim 1, wherein a positive electrode comprises at least one positive electrode active material denoted by a general formula selected from the following formulae (4), (5), (6) and (7):
LiMn₂₋ₓMₓO₄ (4)
wherein 0<x<0.3, and M is a metal element and comprises at least one selected from Li, Al, B, Mg, Si, and transition metals,
Liₐ(MₓMn_{2-x-y}Y_{y})(O_{4-w}Z_{w}) (5)
wherein 0.4≤x≤1.2, 0≤y, x+y<2, 0≤a≤1.2, 0≤w≤1, M is a transition metal element and comprises at least one selected from the group consisting of Co, Ni, Fe, Cr and Cu, Y is a metal element and comprises at least one selected from the group consisting of Li, B, Na, Al, Mg, Ti, Si, K and Ca, and Z is at least one selected from the group consisting of F and Cl,
Li(LiₓM_{1-x-z}Mn_{z})O₂ (6)
wherein 0.1≤x<0.3, 0.33≤z≤0.7, and M is at least one of Co and Ni,
LiMPO₄ (7)
wherein M is at least one of Co and Ni.

10. A method of producing a secondary battery comprising:
a step of arranging a positive electrode and a negative electrode so as to face each other via a separator to produce an electrode element and
a step of enclosing the electrode element and the electrolyte solution for secondary batteries according to claim 1 in an outer package.
